(19) United States
(12) Patent Application Publication
(10) Pub. No.: US 2026/0329575 A1
(43) Pub. Date: Oct. 22, 2026

(54) RUNTIME FIRMWARE UPDATES USING HOTPATCHING

(71) Applicant: Microsoft Technology Licensing, LLC, REDMOND, WA (US)

(72) Inventors: James George CAVALARIS, Bothell, WA (US); Timothy Forrest PHILLIPS, Fuquay Varina, NC (US); Naga Kiran GOVINDARAJU, Yarrow Point, WA (US); Terence Kwok Tak CHAN, Redmond, WA (US); Daini XIE, Redmond, WA (US)

(21) Appl. No.: 19/185,735

(22) Filed: Apr. 22, 2025

(51) Int. Cl. G06F 8/656; G06F 9/48

(52) U.S. Cl. CPC G06F 8/656; G06F 9/4812

(57) ABSTRACT

Methods, apparatuses, and products for runtime firmware updates using hotpatching, including: storing, in a runtime buffer, a firmware update patch comprising an updated code segment for a firmware module loaded into system memory for execution; adding, to the firmware module and at a location corresponding to a code segment updated by the updated code segment, a redirect command directed to the updated code segment; and wherein the redirect command, when executed, causes the updated code segment to be executed instead of the code segment.

### BACKGROUND

Firmware is software that provides low-level control for a computer’s hardware components. On startup, a computer loads firmware from a firmware image, which is a file stored in non-volatile memory, into a region of system memory where a processor can execute the firmware code. The processor continues executing the firmware code as long as the system remains powered on.

Firmware code may need to be periodically updated for various reasons. For example, firmware may be updated to fix bugs, improve performance, add new features, and the like. Some existing approaches for updating firmware require modifying the firmware image itself in non-volatile storage. Because these changes do not modify the firmware already loaded into system memory, they do not immediately affect the firmware at runtime. In order for these changes to take effect, the system must be restarted so that the modified firmware image can be loaded. This may produce significant downtime while the system restarts. Such downtime can be particularly disruptive in mission-critical systems or environments where high availability is required.

Other approaches for updating firmware allow for changes to take effect at runtime without a full system restart. For example, a Unified Extensible Framework Interface (UEFI) Runtime Patch (URP) may be used to replace a firmware module loaded from a firmware image with a different firmware module. Although this method allows for runtime updates, it requires replacing an entire firmware module, which can be inefficient if only minor changes are needed. Moreover, some approaches may still require restarting the operating system or firmware interface for these changes to take effect, introducing downtime or latency. This latency may be unacceptable in systems requiring continuous operation or minimal service disruption.

### SUMMARY

According to embodiments of the present disclosure, various methods, apparatus, and products for runtime firmware updates using hotpatching are described herein. In some aspects, runtime firmware updates using hotpatching includes: storing, in a runtime buffer, a firmware update patch comprising an updated code segment for a firmware module loaded into system memory for execution; adding, to the firmware module and at a location corresponding to a code segment updated by the updated code segment, a redirect command directed to the updated code segment; and wherein the redirect command, when executed, causes the updated code segment to be executed instead of the code segment. In some aspects, an apparatus may include a memory and one or more processing devices, operatively coupled to the memory, the one or more processing devices configured to perform similar steps. In some aspects, a computer program product comprising a computer readable storage medium may store computer program instructions that, when executed, perform similar steps.

### BRIEF DESCRIPTION OF DRAWINGS

FIG. 1 sets forth a diagram of an example computing device for runtime firmware updates using hotpatching in accordance with one or more embodiments.

FIG. 2 sets forth a flow chart illustrating an example method of runtime firmware updates using hotpatching in accordance with one or more embodiments.

FIG. 3 sets forth a flow chart illustrating an additional example method of runtime firmware updates using hotpatching in accordance with one or more embodiments.

FIG. 4 sets forth a flow chart illustrating an additional example method of runtime firmware updates using hotpatching in accordance with one or more embodiments.

FIG. 5 sets forth a flow chart illustrating an additional example method of runtime firmware updates using hotpatching in accordance with one or more embodiments.

FIG. 6 sets forth a flow chart illustrating an additional example method of runtime firmware updates using hotpatching in accordance with one or more embodiments.

FIG. 7 illustrates an exemplary computing device that may be specifically configured to perform one or more of the processes described in the present disclosure.

FIG. 8 sets forth a block diagram of a cloud service provider service architecture in accordance with one or more embodiments of the present disclosure.

### DESCRIPTION OF EMBODIMENTS

Computers use firmware for low-level control of computer hardware. On startup, a computer loads firmware from non-volatile memory into system memory, where a processor executes firmware instructions. The firmware remains in system memory and executes continuously while the system remains powered. Systems may require periodic firmware updates to address security vulnerabilities, fix software defects, or introduce new functionality. However, traditional update mechanisms often interrupt system availability.

Existing methods for updating system firmware often require replacing the entire firmware image stored in non-volatile memory with an updated version. To apply the update, the system restarts to load and execute the updated firmware in system memory. During this restart process, the system remains unavailable, leading to downtime for services, programs, or workloads executing on the system. Alternative methods allow for updating a module within the firmware image without restarting the entire system. However, these updates still require restarting the runtime firmware environment, which can disrupt normal operation. Though this does not require as much time as restarting the entire system, it may still require restarting the operating system or halting execution of the operating system and applications for the amount of time necessary to reinitialize the firmware.

To address these limitations, the techniques set forth herein provide a mechanism for updating firmware during runtime without requiring a system restart or reinitialization of the firmware environment. In one or more embodiments, an updated code segment corresponding to a portion of firmware is loaded into system memory. A redirection mechanism may be introduced to direct execution flow from the original code segment to the updated segment. During firmware execution, the redirect command will cause the updated code segment to be executed instead of the portion of code that was updated. As a result, firmware execution is seamlessly modified without requiring a system reset or downtime.

Maintaining system performance and security may require firmware updates. The disclosed techniques enable firmware updates to take effect without requiring a system reboot, minimizing downtime and improving system availability. In addition to reducing overall downtime, these techniques allow firmware updates to be quickly deployed without needing to factor in system downtime in determining when to apply these updates, allowing for security and/or performance improvements to take effect sooner.

The disclosed techniques provide a technical benefit by eliminating the need for firmware reinitialization, allowing the system to execute updated code without suspending active processes. This approach significantly reduces latency in firmware update deployment, enhances system security by enabling immediate patch application, and prevents service disruptions that typically arise from traditional firmware update methods. Additionally, because updates take effect dynamically, the system avoids memory overhead associated with maintaining separate execution states for legacy and updated firmware. These advantages improve the efficiency and responsiveness of firmware update mechanisms, making them more suitable for systems requiring high availability and real-time operation.

By enabling seamless firmware updates without system downtime, the disclosed techniques reduce operational disruptions, allowing businesses to maintain continuous service availability. This capability minimizes revenue loss associated with system outages, enhances security compliance by ensuring faster patch deployment, and improves customer satisfaction by delivering a more reliable and resilient computing environment.

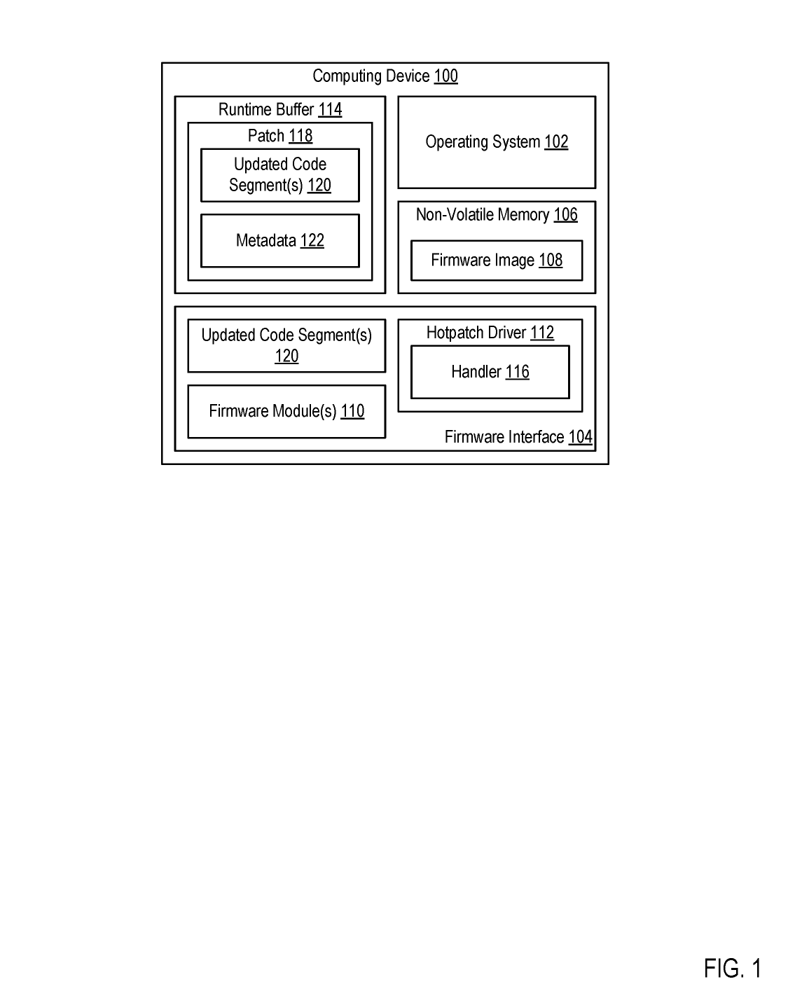

FIG. 1 sets forth a diagram of an example computing device 100 for runtime firmware updates using hotpatching in accordance with one or more embodiments of the present disclosure. The example computing device 100 may include any type of computing device 100 as can be appreciated. For example, the computing device 100 may include a personal computer, a mobile device, a server, or another computing device 100 as can be appreciated. The computing device 100 executes an operating system 102 and a firmware interface 104. The operating system 102 is software that manages the hardware and software resources of the computing device 100 and provides common services for programs or other software executed in the computing device 100. The operating system 102 may include any type of operating system 102 as can be appreciated, such as a Windows operating system 102.

The firmware interface 104 is a software interface controlling how the operating system 102 interacts with firmware of the computing device 100. In one or more embodiments, the firmware interface 104 includes a Unified Extensible Firmware Interface (UEFI) firmware interface 104, a firmware interface 104 adhering to the UEFI specification. In one or more embodiments, the firmware interface 104 includes another type of firmware interface 104 as can be appreciated. Firmware for the computing device 100 is stored in non-volatile memory 106 as a firmware image 108. The firmware image 108 is a file storing firmware for the computing device 100. In one or more embodiments, the firmware image 108 includes one or more firmware modules 110, with each firmware module 110 including some portion of firmware code. In one or more embodiments, each firmware module 110 may include a different file or other portion of firmware code as can be appreciated. In one or more embodiments, the firmware modules 110 include firmware modules 110 supporting UEFI System Management Mode (SMM).

The non-volatile memory 106 is persistent storage from which the firmware image 108 is loaded by the firmware interface 104. For example, in one or more embodiments, the non-volatile memory 106 includes non-volatile random access memory (NVRAM) or other non-volatile storage as can be appreciated. In one or more embodiments, as part of booting the computing device 100, the firmware interface 104 may be loaded before the operating system 102 and load the firmware image 108 from non-volatile memory 106. The firmware modules 110 of the firmware image 108 may then be stored in system memory for execution.

In one or more embodiments, the firmware interface 104 may support runtime patching of firmware modules 110. For example, in one or more embodiments, the firmware interface 104 may include a UEFI firmware interface 104 that supports UEFI Runtime Patching (URP). Using URP, drivers and other firmware modules 110 may be loaded into memory and executed at runtime, allowing for new drivers and firmware modules 110 to be added and for existing firmware modules 110 to be updated. Using URP, a firmware module 110 can be updated by loading a replacement firmware module 110 into memory and replacing any callbacks or extension points registered with the system by the original version with the replacement firmware module 110. While firmware modules 110 can be updated and patched at runtime using URP it requires replacing the entire firmware module 110 with an updated version and also requires careful design to ensure that no part of the original firmware module 110 can execute after the update. Other approaches for applying firmware updates at runtime may include deploying an update to a firmware module 110 (e.g., using Management Mode Runtime Updates) or a firmware image 108, after which the runtime firmware environment must be reset. This may necessitate restarting or halting execution of the operating system 102 and/or programs for some amount of time to reinitialize the firmware. In other words, existing implementations for updating firmware at runtime require full replacement of a firmware module 110 or firmware image 108 and may introduce appreciable downtime in order for the firmware environment or firmware interface 104 to reinitialize.

To address these concerns, the approaches set forth herein provide for runtime updates to firmware through hotpatching. As described herein, hotpatching is a process for updating executing code without the need to restart the system or an updated process. Within the context of firmware, hotpatching is the process of updating firmware code without the need to restart the operating system 102 or the firmware interface 104. Moreover, as will be described in further detail below, hotpatching firmware allows for runtime updates to firmware without fully replacing a firmware module 110 or a firmware image 108.

In one or more embodiments, runtime firmware updates using hotpatching as described herein is performed at least partially using a hotpatch driver 112. A hotpatch driver 112 is a firmware driver that modifies firmware modules 110 for runtime firmware updates using hotpatching as will be described in further detail below. In one or more embodiments, the hotpatch driver 112 is not included in the firmware image 108 loaded by the firmware interface 104 on startup. Accordingly, in one or more embodiments, the operating system 102 may load the hotpatch driver 112 into the firmware interface 104 for use.

For example, in one or more embodiments, the operating system 102 stores the hotpatch driver 112 into a runtime buffer 114, an area of memory accessible to both the operating system 102 and the firmware interface 104. The operating system 102 may generate a command, signal, interrupt, or another event that, when detected by the firmware interface 104, causes the firmware interface 104 to load the hotpatch driver 112 from the runtime buffer 114 into system memory for execution. In one or more embodiments, the hotpatch driver 112 may be implemented as a URP driver that can be loaded for use and updated over time using URP. In one or more embodiments, the hotpatch driver 112 may be loaded into a region of memory accessible to the firmware interface 104 but inaccessible to the operating system 102, such as System Management RAM (SMRAM). The firmware interface 104 may then activate or execute the hotpatch driver 112.

In one or more embodiments, in response to activation or execution, the hotpatch driver 112 registers a handler 116 that allows for the operating system 102 to communicate and/or interact with the hotpatch driver 112. The handler 116 is a subroutine of code that is executed in response to a particular event. In one or more embodiments, the handler 116 includes an interrupt handler 116 that is executed in response to an interrupt event. For example, in one or more embodiments, the handler 116 includes a System Management Interrupt (SMI) handler 116 executed in response to a SMI event. A SMI event is an interrupt event that causes the computing device 100 to enter a System Management Mode (SMM) whereby execution of all threads, including the operating system 102, are suspended and some other code (e.g., the handler 116) is executed.

In one or more embodiments, in order to update a firmware module 110 using hotpatching, the operating system 102 stores a patch 118 into the runtime buffer 114. A patch 118 is an encapsulation or package of data used to hotpatch a firmware module 110. In one or more embodiments, a patch 118 includes one or more updated code segments 120. An updated code segment 120 is a portion of executable code, such as assembly code or other executable code, to be executed instead of some corresponding portion of code in a firmware module 110. For example, in one or more embodiments, an updated code segment 120 may correspond to a function in a firmware module 110. In other words, an updated code segment 120 may serve as an update to a function in a firmware module 110. Particularly, in one or more embodiments, an updated code segment 120 may include an update to the body of a function such that only functional steps of the function, not the parameters or data structures used by these functions, may be changed by an updated code segment 120. Put differently, each updated code segment 120 corresponds to some existing code segment in a firmware module 110 such that, after applying the patch 118, the updated code segment 120 of the patch 118 will be executed instead of the corresponding existing code segment.

In one or more embodiments, a patch 118 may include multiple updated code segments 120. In one or more embodiments, the multiple updated code segments 120 may include multiple updates to the same firmware module 110 and/or to different firmware modules 110. For example, in one or more embodiments, a patch 118 may update the same firmware module 110 using multiple different updated code segments 120 (e.g., for different functions in that firmware module 110). As another example, in one or more embodiments, a patch 118 may update multiple different firmware modules 110 using multiple updated code segments 120.

In one or more embodiments, a patch 118 may include metadata 122. The metadata 122 may include various attributes related to the updated code segments 120, their application to firmware modules 110, and the like. In one or more embodiments, the metadata 122 may include a header. Such a header may include a manifest identifying the included updated code segments 120 and/or other data included in the patch 118. Such a header may also include other information. For example, the header may indicate that the patch 118 is a patch 118 to be applied as a hotpatch (e.g., as opposed to a URP capsule or other type of patch). In one or more embodiments, the metadata 122 may include one or more version identifiers for a firmware image 108 and/or firmware modules 110 to which the updated code segments 120 should be applied. In one or more embodiments, the metadata 122 includes verification and/or integrity information such as a signature, a public key used to generate the signature, and the like. In one or more embodiments, the metadata 122 may indicate an order in which updated code segments 120 should be applied to the firmware modules 110. In other words, in one or more embodiments, the metadata 122 may indicate an order in which the firmware modules 110 should be modified or updated to use the updated code segments 120 of the patch 118.

In one or more embodiments, the patch 118 may include a URP capsule, a data encapsulation format used for URP. In one or more embodiments, where the patch 118 includes a URP capsule, the metadata 122 (e.g., the header) of the patch 118 may indicate that the patch 118 is to be applied as a hotpatch. This may be used to distinguish the patch 118 from other URP capsules that may perform runtime firmware updates by replacing an entire firmware module 110 or firmware image 108 as described above. In one or more embodiments, the patch 118 may be encoded using some other format.

After storing the patch 118 in the runtime buffer 114, the operating system 102 indicates, to the hotpatch driver 112, that a patch 118 is available for application. In one or more embodiments, this includes generating a SMI event that triggers the handler 116 of the hotpatch driver 112. The SMI event will cause the computing device 100 to enter a SMM operating mode, suspending all threads other than the handler 116. In one or more embodiments, the handler 116 will read the contents of the runtime buffer 114 to detect the stored patch 118. In one or more embodiments, the handler 116 may load the updated code segments 120 and/or the metadata 122 from the patch 118 in the runtime buffer 114 into SMRAM or some other region of memory inaccessible to the operating system 102 but accessible to the firmware interface 104.

In one or more embodiments, the handler 116 may access the metadata 122 of the patch 118 to determine how to process and apply the patch 118. For example, the metadata 122 of the patch 118 may indicate that the patch 118 is a hotpatch as opposed to a URP capsule that requires replacing an entire firmware module 110 or firmware image 108. In one or more embodiments, the handler 116 may invoke or execute other drivers depending on the particular type of patch 118 to be applied. For example, the handler 116 may execute different drivers to apply hotpatches and/or URP capsules depending on the contents of the patch 118 metadata 122, effectively routing or delegating application of the patch 118 to the appropriate other driver.

The handler 116 then modifies one or more firmware modules 110 based on the updated code segment(s) 120 in the patch 118. Particularly, the handler 116 modifies the one or more firmware modules 110 such that, when executing the one or more firmware modules 110, an updated code segment 120 is executed instead of a corresponding code segment of the firmware module 110. To do so, the handler 116 inserts a redirect command into a firmware module 110 at a location of the code segment to be updated that redirects execution from the firmware module 110 to a corresponding updated code segment 120. The redirect command may include, for example, a jump instruction or another executable instruction as can be appreciated. In one or more embodiments, the redirect command may be inserted at the beginning of code segment of the firmware module 110 to be updated such that the redirect command is executed rather than the rest of code segment.

For example, assume that a function of a firmware module 110 is to be updated using a patch 118. In this example, the patch 118 includes an updated code segment 120 for the body of the method. To hotpatch the firmware module 110, a redirect command may be inserted at the beginning of the function in the firmware module 110 such that executing the function causes the redirect command to be executed. This will redirect execution to the updated code segment 120, allowing the updated function body of the updated code segment 120 to be executed instead of the original function body in the firmware module 110. In one or more embodiments, the metadata 122 for the patch 118 may indicate, in the executable code of a firmware module 110 to be patched, where the corresponding redirect instruction should be inserted. This may include, for example, a line or instruction number, an address, an offset relative to some other address, or another identifier as can be appreciated. In one or more embodiments, after executing the updated code segment 120 using the redirect command, execution may return to the instruction address that initially called the function of the firmware module 110.

In one or more embodiments, to insert a redirect command in a firmware module 110, the firmware module 110 must have space available in which to insert the redirect command. In one or more embodiments, a compiler may be configured to insert some number of empty bytes at the beginning of a function as padding (e.g., before any functional instructions). In such embodiments, the redirect command may be inserted into one of these empty bytes by overwriting some amount of this padding with an instruction for the redirect command. In one or more embodiments, this may necessitate recompiling the firmware module 110 and/or the firmware image 108 to include these empty bytes at the beginning of the functions. For example, in one or more embodiments, code for the firmware module 110 and/or firmware image 108 may be compiled with an option or parameter defining an amount of padding (e.g., as bytes) to include at the beginning of a function of executable compiled code.

After adding the redirect commands to the firmware modules 110 directed to the updated code segments 120 in the patch 118, the handler 116 may finish execution by releasing the operational mode (e.g., the SMM operational mode) entered in response to the interrupt. Readers will appreciate that, as the operational mode prevents execution of any threads other than the handler 116, no other firmware processes will be executed while executing the handler 116. This ensures that no other firmware process or thread will modify the region of memory used by the handler to store updated code segments 120 and to store and modify firmware modules 110 to include redirect commands directed to these updated code segments 120.

In one or more embodiments, a firmware module 110 hotpatched using a patch 118 may be further modified over time. In one or more embodiments, a previously hotpatched firmware module 110 may have the hotpatch removed by removing the inserted redirect commands, thereby reverting the firmware module 110 to its state prior to hotpatching. This may include, for example, overwriting a redirect command with padding (e.g., empty bytes) or by otherwise removing the redirect command. In one or more embodiments, a hotpatch may be removed by the operating system 102 generating another interrupt event (e.g., another SMI event) that causes the handler 116 or another handler 116 of the hotpatch driver 112 to remove the previously added redirect commands.

In one or more embodiments, a patch 118 may be encoded or constructed such that, when detected by a hotpatch driver 112, indicates that a previously applied patch 118 should be undone or reverted. For example, in one or more embodiments, a patch 118 may include specific header information, an empty payload of updated code segments 120, or some other data. The operating system 102 may load this patch 118 into the runtime buffer 114 and signal, to the hotpatch driver 112, that a patch 118 is available (e.g., using an interrupt event or another command or signal). After accessing the patch 118 in the runtime buffer 114, the hotpatch driver 112 may remove the previously added redirect commands and/or may delete the updated code segments 120 referenced by these redirect commands.

In one or more embodiments, where a patch 118 applied multiple updated code segments 120, thereby necessitating the addition of multiple redirect commands, these multiple redirect commands may be removed in an order reversed from which they were added. For example, where the metadata 122 indicates a particular order in which redirect commands should be added for a patch 118, these redirect commands may be removed in the reverse order from the order indicated in the metadata 122. Accordingly, in one or more embodiments, the metadata 122 for a patch 118 may be maintained in system memory after being loaded from the patch 118 in the runtime buffer 114 for subsequent use, if needed.

In one or more embodiments, a previously hotpatched firmware module 110 may be hotpatched again to further modify the firmware module 110 to use different updated code segments 120 in a different patch 118. In one or more embodiments, this may be performed using similar approaches as are set forth above for applying a patch 118. For example, a new patch 118 may be stored (e.g., by the operating system 102) into a runtime buffer 114 accessible to a handler 116 of a hotpatch driver 112. The operating system 102 may then generate an interrupt event that causes the handler 116 to load updated code segments 120 and/or metadata 122 from the patch 118 in the runtime buffer 114 into system memory. The handler 116 may then add redirect commands to the firmware module 110 directed to these updated code segments 120.

In one or more embodiments, further hotpatching a previously hotpatched firmware module 110 may include removing the previously applied hotpatch. Accordingly, in one or more embodiments, in response to detecting a patch 118 for a previously patched firmware module 110 or firmware image 108, the handler 116 may revert the firmware module 110 by removing the previously added redirect commands as described above. The new patch 118 may then be applied by inserting redirect commands into the reverted firmware module 110.

Readers will appreciate that the approaches set forth herein allow for runtime hotpatching of firmware modules 110, allowing for the functionality of firmware modules 110 to be updated without requiring a full system restart or a restart of the firmware interface 104 and/or operating system 102. This allows for firmware modules 110 to be updated without significant system downtime. Moreover, these approaches allow for firmware modules 110 to be updated without fully replacing a firmware module 110 or firmware image 108.

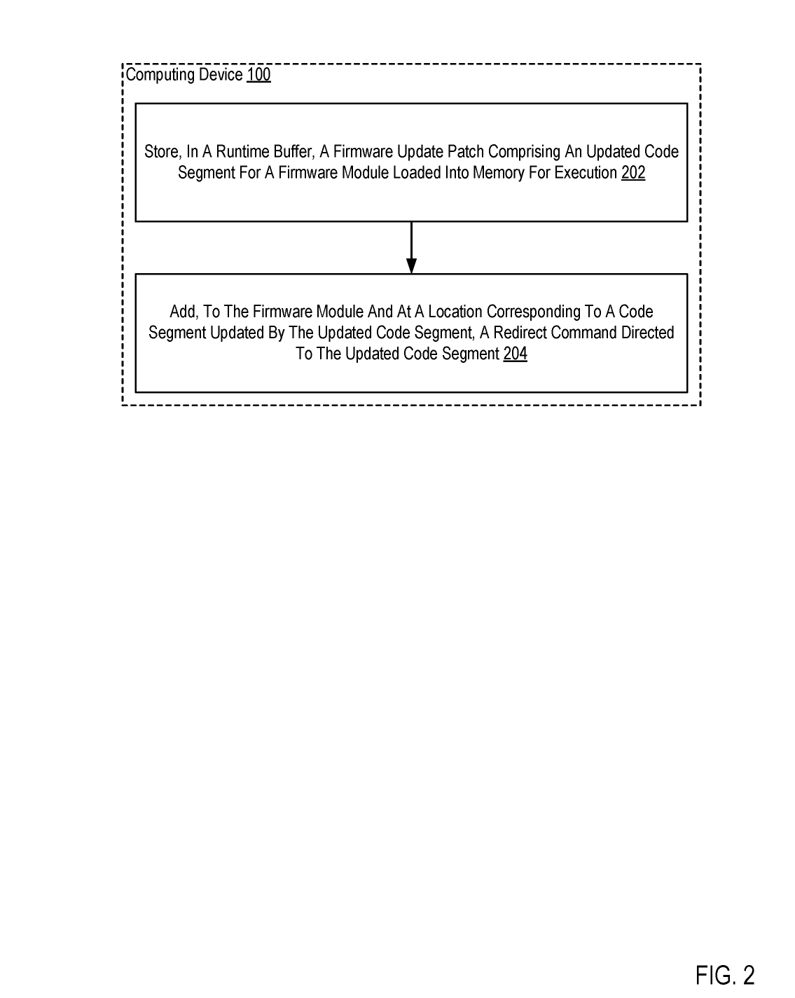

For further explanation, FIG. 2 sets forth a flowchart of an example method of runtime firmware updates using hotpatching in accordance with one or more embodiments of the present disclosure. The method of FIG. 2 may be performed, for example, in a computing device 100 of FIG. 1. The method of FIG. 2 includes storing 202, in a runtime buffer 114, a firmware update patch 118 comprising an updated code segment 120 for a firmware module 110 loaded into memory for execution. The firmware update patch 118 includes an updated code segment 120 corresponding to some existing code segment in the firmware module 110. For example, the updated code segment 120 may include an updated body for a function or method of the firmware module 110.

The firmware module 110 may include a firmware module 110 of a firmware image 108 loaded from non-volatile memory 106 into system memory for execution (e.g., by a firmware interface 104). In one or more embodiments, the runtime buffer 114 is an area of memory (e.g., in RAM) accessible to both an operating system 102 and a firmware interface 104 of the computing device 100. Accordingly, in one or more embodiments, storing 202 the firmware update patch 118 includes storing 202 the firmware update patch 118 into the runtime buffer 114 by the operating system 102. In one or more embodiments, the operating system 102 may generate a signal to a hotpatch driver 112, such as a SMI event, indicating that the patch 118 has been stored 202 into the runtime buffer 114.

The method of FIG. 2 also includes adding 204, to the firmware module 110 and at a location corresponding to a code segment updated by the updated code segment 120, a redirect command directed to the updated code segment 120. The redirect command is an instruction, such as a jump instruction, that, when executed, redirects execution to some other execution. Here, the executing the redirect command redirects execution of the firmware module 110 to the updated code segment 120. For example, assume that the updated code segment 120 is an updated function body for some function in the firmware module 110. When executing this function, the redirect command will redirect execution from the function in the firmware module 110 to the updated code segment 120. The updated function body in the updated code segment 120 will be executed instead of the original function body. In one or more embodiments, after executing the updated code segment 120, execution will return to wherever originally called the original function. For example, when calling the function, a return address may be added to a return address stack. After being redirected to and executing the updated code segment 120, this return address may be accessed from the return address stack, redirecting execution to the address in the return address stack. Thus, the original function was omitted, instead executing the updated code segment 120.

In one or more embodiments, the redirect command may be added 204 to the beginning of a code segment updated by the updated code segment 120. In one or more embodiments, the redirect command may be added 204 to padding encoded at the beginning of a function or method during compilation of the firmware module 110. For example, in one or more embodiments, a compiler setting may add some number of empty bytes as padding at the beginning of a function or method. Accordingly, in one or more embodiments, the redirect command may be added 204 by overwriting a portion of this padding with the instruction for the redirect command.

In one or more embodiments, the redirect command may be directed to the updated code segment 120 as stored in a region of memory usable or accessible by firmware (e.g., by the firmware interface 104 and/or firmware drivers) during execution. In one or more embodiments, this region of memory may be inaccessible (e.g., lacking write and/or read access) to the operating system 102. For example, in one or more embodiments, this region of memory may include a region of SMRAM or other memory as can be appreciated. Accordingly, in one or more embodiments, to add 204 the redirect command to the firmware module 110, the updated code segment 120 must be loaded from the firmware update patch 118 in the runtime buffer 114 and stored into this region of memory. For example, in one or more embodiments, a hotpatch driver 112 may load the updated code segment 120 from the firmware update patch 118 and into this region of memory in response to a command or signal from the operating system 102 such as an SMI or another interrupt event as can be appreciated. Thus, both the firmware module 110 and the updated code segment 120 may be stored in this region of memory for execution. The redirect command added to the firmware module 110 will be directed to (e.g., will include an instruction address for) the updated code segment 120 as stored in this region of memory.

In one or more embodiments, metadata 122 of the firmware update patch 118 may be used to facilitate adding 204 the redirect command. In one or more embodiments, the metadata 122 may include identifiers for a firmware image 108 and/or firmware module 110 to which the updated code segment 120 applies. Such identifiers may include version identifiers, header information, hashes, or other information as can be appreciated. Accordingly, in one or more embodiments, adding 402 the redirect command may include determining that the firmware image 108 and/or the firmware module 110 loaded into memory for execution match the identifier included in the metadata 122. In one or more embodiments, adding 204 the redirect command may continue in response to these identifiers matching. Should these identifiers not match, indicating that the updated code segment 120 is intended to apply to a firmware image 108 and/or module 110 not currently loaded into memory, the redirect command will not be added 204.

In one or more embodiments, the metadata 122 may include a signature and/or public key for the firmware update patch 118. In one or more embodiments, adding 204 the redirect command may continue in response to verifying this signature (e.g., using the public key). In one or more embodiments, where the signature cannot be verified, the redirect command will not be added 204. In one or more embodiments, failure to verify this signature may cause an error or other event to be raised.

In one or more embodiments, the hotpatch driver 112 may determine a patch type for the firmware update patch 118. For example, in one or more embodiments, a firmware update patch 118 may include a hotpatch as described herein or a URP capsule whereby a firmware module 110 is fully replaced with another firmware module 110 in the URP capsule. Accordingly, in one or more embodiments, the hotpatch driver 112 may access header information (e.g., in metadata 122) or other data in the firmware update patch 118 to determine the patch type. In one or more embodiments, the hotpatch driver 112 may apply the firmware update patch 118, or may delegate application of the firmware update patch 118 to another driver, based on the determined patch type. For example, the redirect command may be added 204 in response to determining that the firmware update patch 118 is a hotpatch while a firmware module 110 may be fully replaced in response to determining that the firmware update patch 118 is a URP capsule.

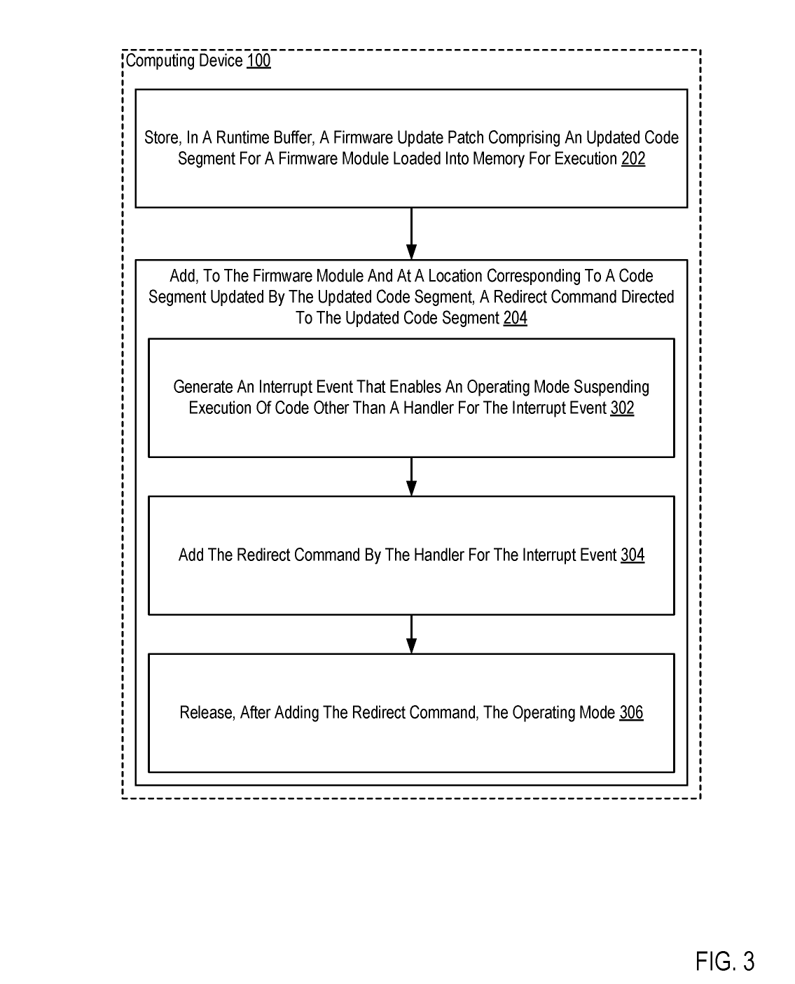

For further explanation, FIG. 3 sets forth a flowchart of another example method of runtime firmware updates using hotpatching in accordance with one or more embodiments of the present disclosure. The method of FIG. 3 is similar to FIG. 2, differing in that adding 204, to the firmware module 110 and at a location corresponding to a code segment updated by the updated code segment 120, a redirect command directed to the updated code segment 120 also includes generating 302 an interrupt event that enables an operating mode suspending execution of code other than a handler 116 for the interrupt event. In one or more embodiments, a hotpatch driver 112 may be loaded or installed to facilitate updating firmware modules 110 to execute updated code segments 120 in firmware update patches 118. For example, in one or more embodiments, a hotpatch driver 112 may be loaded (e.g., into the region of memory used for executing firmware) as an SMM driver after loading the initial firmware image 108 from non-volatile memory 106. Once loaded, the hotpatch driver 112 may register a handler 116 for the interrupt event such that, when the interrupt event is generated 302, the handler 116 will be executed.

In one or more embodiments, adding 204, to the firmware module 110 and at a location corresponding to a code segment updated by the updated code segment 120, a redirect command directed to the updated code segment 120 also includes adding 304 the redirect command by the handler 116 for the interrupt event. The handler 116 may add 304 the redirect command to the firmware module 110 using similar approaches as are set forth above. The operating mode suspends execution of code other than the handler 116 so that the handler 116 can operate in the region of memory allocated to firmware execution without the need to account for other threads accessing or modifying that memory, including accessing or modifying the firmware module 110 and/or the updated code segment 120. In one or more embodiments, this operating mode may include a SMM operating mode.

In one or more embodiments, adding 204, to the firmware module 110 and at a location corresponding to a code segment updated by the updated code segment 120, a redirect command directed to the updated code segment 120 also includes releasing 306, after adding the redirect command, the operating mode. In one or more embodiments, releasing 306 the operating mode may be performed in response to the handler 116 completing execution. Releasing 306 the operating mode allows other threads or code to resume execution. Where this code execution includes executing the firmware module 110, the redirect command may be executed as described above so as to force execution of the updated code segment 120 instead of the corresponding code segment in the firmware module 110.

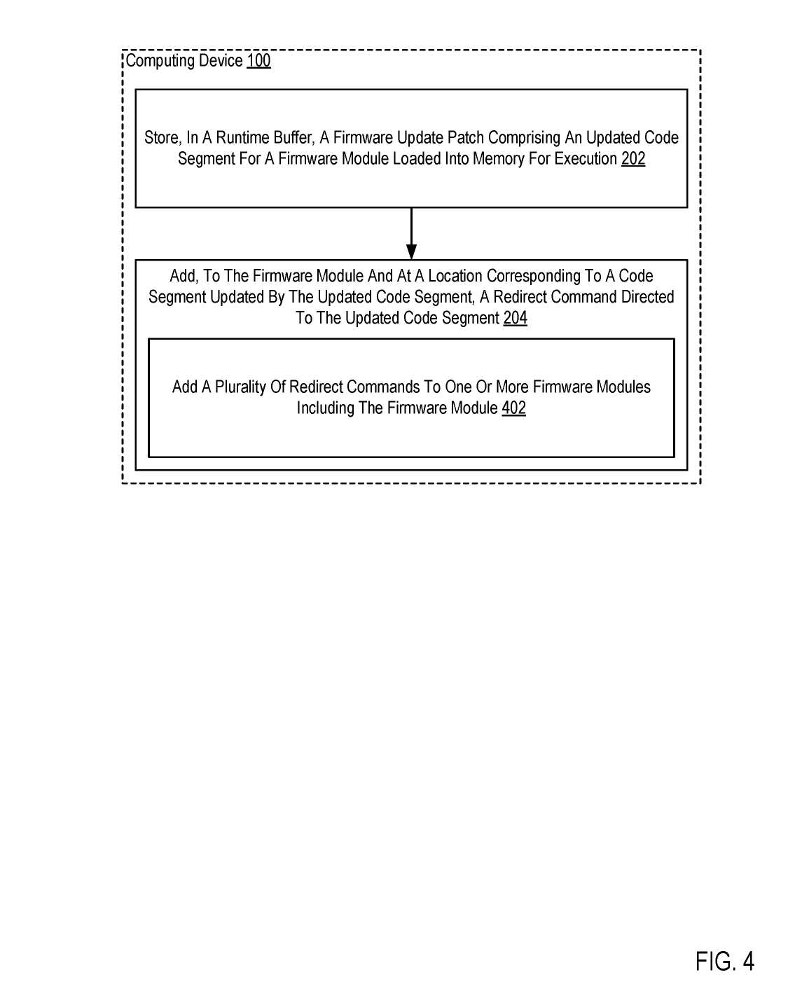

For further explanation, FIG. 4 sets forth a flowchart of another example method of runtime firmware updates using hotpatching in accordance with one or more embodiments of the present disclosure. The method of FIG. 4 is similar to FIG. 3, differing in that adding 204, to the firmware module 110 and at a location corresponding to a code segment updated by the updated code segment 120, a redirect command directed to the updated code segment 120 also includes adding 402 a plurality of redirect commands to one or more firmware modules 110 including the firmware module 110. In one or more embodiments, a firmware update patch 118 may include multiple updated code segments 120 each corresponding to different code segments of one or more firmware modules 110. For example, a firmware update patch 118 may include multiple updated code segments 120 for different code segments of the same firmware module 110 and/or different firmware modules 110. Accordingly, in one or more embodiments, redirect commands directed to each of these updated code segments 120 may be added to the corresponding locations in the one or more firmware modules 110.

In one or more embodiments, the firmware update patch 118 includes metadata 122 that may be used in adding 402 the redirect commands for the multiple updated code segments 120. In one or more embodiments, the metadata 122 may identify, for each updated code segment 120, a location (e.g., an address and/or an offset) in a firmware module 110 where the corresponding redirect command should be added. Accordingly, in one or more embodiments, the redirect commands may be added 402 to the locations in the firmware module(s) 110 indicated in the metadata 122. In one or more embodiments, the metadata 122 may define an order for adding 402 the redirect commands. Accordingly, in one or more embodiments, the redirect commands may be added 402 in the order defined in the metadata 122.

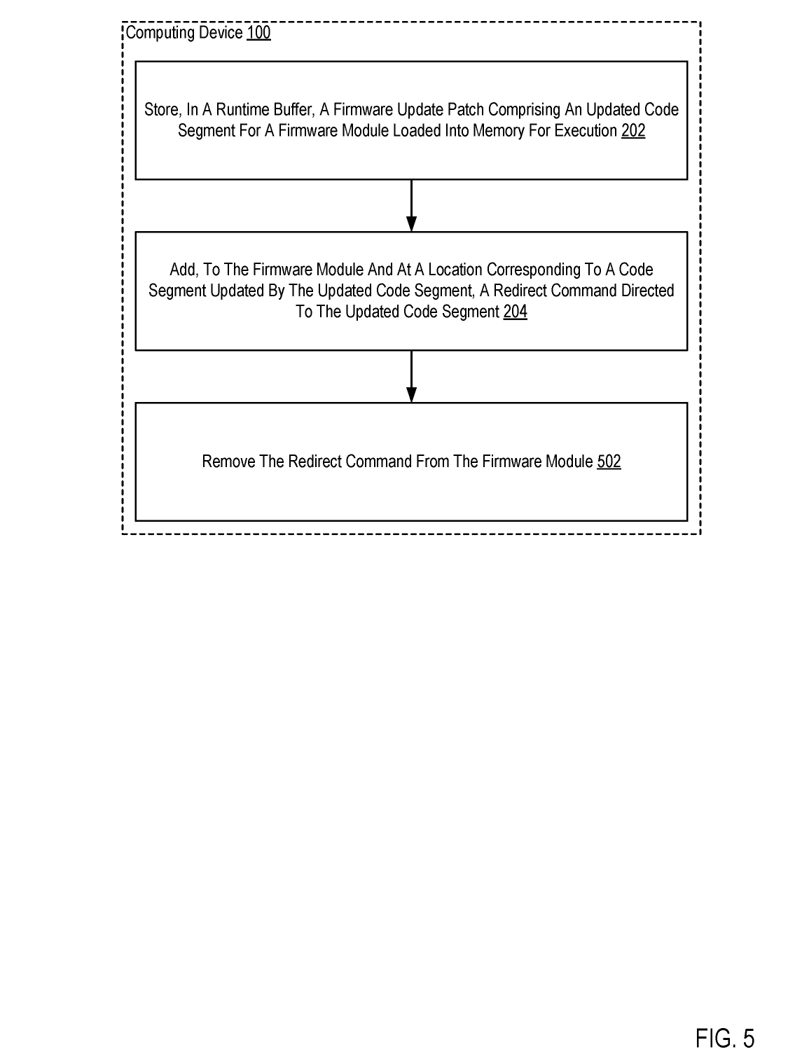

For further explanation, FIG. 5 sets forth a flowchart of another example method of runtime firmware updates using hotpatching in accordance with one or more embodiments of the present disclosure. The method of FIG. 5 is similar to FIG. 4, differing in that the method of FIG. 5 also includes removing 502 the redirect command from the firmware module 110. In one or more embodiments, a previously applied firmware update patch 118 may be removed or reverted for various purposes. For example, a firmware update patch 118 may be removed where the updated code segment 120 produced unwanted behavior, or where a new firmware update patch 118 is to be applied. Accordingly, this previously applied firmware update patch 118 may be removed by removing the previously added 204 redirect command directed to the updated code segment 120 of the firmware update patch 118 to be removed.

In one or more embodiments, removing 502 the redirect command from the firmware module 110 may be performed in response to a command or signal to the hotpatch driver 112. For example, in one or more embodiments, the operating system 102 may generate a particular interrupt, command, or signal that, when detected by the hotpatch driver 112, initiates removal of a previously applied firmware update patch 118. In one or more embodiments, removing 502 the redirect command from the firmware module 110 may be performed in response to detecting a firmware update patch 118 in the runtime buffer 114 with a particular payload or metadata 122 indicating that a previously applied firmware update patch 118 should be removed. In one or more embodiments, removing 502 the redirect command from the firmware module 110 may be performed in response to detecting a new firmware update patch 118 with new updated code segments 120 in the runtime buffer 114 (e.g., in response to an interrupt or other signal as is set forth above). Accordingly, in response to one or more of these conditions to remove a previously applied firmware update patch 118, the previously added 204 redirect command may be removed. In one or more embodiments, the updated code segment 120 referenced by this redirect command may also be deleted.

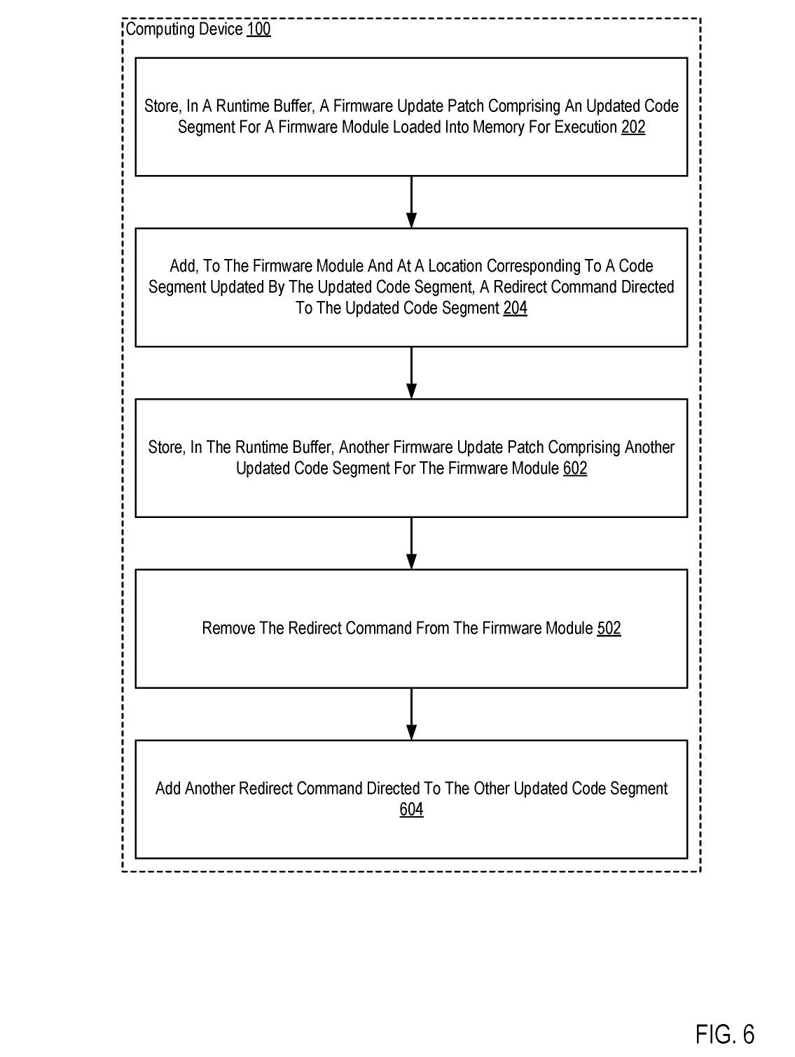

For further explanation, FIG. 6 sets forth a flowchart of another example method of runtime firmware updates using hotpatching in accordance with one or more embodiments of the present disclosure. The method of FIG. 6 is similar to FIG. 5, differing in that the method of FIG. 6 also includes storing 602, in the runtime buffer 114, another firmware update patch 118 comprising another updated code segment 120. The other firmware update patch 118 may be stored into the runtime buffer 114 according to similar approaches as are set forth above with respect to storing 202 the firmware update patch 118. In one or more embodiments, the other updated code segment 120 may correspond to the same or a different code segment in the firmware module 110 as the updated code segment 120 of the previously stored 202 firmware update patch 118.

In one or more embodiments, the hotpatch driver 112 may remove 502 the redirect command from the firmware module 110 in response to detecting this other firmware update patch 118 in the runtime buffer 114. As the firmware module 110 has now been reverted to its original state as loaded from the firmware image 108 the other firmware update patch 118 may be applied. Accordingly, the method of FIG. 6 also includes adding 604 another redirect command directed to the other updated code segment 120. For example, the other code segment 120 may be loaded from the other firmware update patch 118 in the runtime buffer 114 into the region of memory used for executing firmware. The other redirect command referencing this other updated code segment 120 may be added to the firmware module 110. Thus, executing the firmware module 110 will now cause the other redirect command and the other updated code segment 120 to be executed.

In one or more embodiments, hotpatching refers to a technique for applying patches to software or firmware while the system remains operational, avoiding a reboot or reinitialization. In the context of firmware, hotpatching may allow for modifications to be applied at runtime by redirecting execution flow from an outdated function to an updated version without requiring full module replacement.

In one or more embodiments, a redirect command is an instruction inserted into a firmware module at a location corresponding to a code segment that has been updated. When executed, this redirect command causes execution flow to jump to the updated code segment. This mechanism may enable targeted function updates without altering memory allocations for existing firmware modules.

In one or more embodiments, unlike traditional firmware update mechanisms, which overwrite entire modules or require system reboots, the techniques and mechanisms described above ensure seamless patch application. The hotpatching process may rely on a compiler-assisted approach that minimizes manual code changes while ensuring compatibility with existing function parameters.

One or more embodiments of the disclosed firmware hotpatching process may leverage System Management Mode (SMM) to ensure safe application of patches without execution conflicts. SMM is a special privileged execution mode in x86-based processors that suspends all non-SMM operations while a designated firmware function executes. When applying a patch, the system enters SMM mode, ensuring that no other threads or processes execute within the firmware environment.

In one or more embodiments, by executing the hotpatching process within SMM mode, the system avoids race conditions that could otherwise occur if an execution redirection were attempted while other processor threads were simultaneously executing firmware functions. This approach ensures that the redirection command is safely written to memory without risking system instability.

In one or more embodiments, the firmware hotpatching mechanism may utilize a dedicated hotpatch SMM driver, which is responsible for managing the patch application process. This driver may be deployed at runtime and may operate in System Management Mode (SMM), allowing it to handle patches safely without interrupting normal system operations. In one or more embodiments, upon receiving a hotpatch, the hotpatch SMM driver may perform the functions such as, for example, loading the updated firmware code segment into system memory in an unused memory region, interpreting patch metadata to determine which function(s) within the firmware module need redirection, inserting redirect commands at the entry points of outdated functions, ensuring that execution is dynamically routed to the new patched functions, and ensuring atomic updates by writing jump instructions only after all preparatory patching steps are completed. In these embodiments, because this driver operates in SMM mode, it ensures that the hotpatch is applied in a controlled execution environment where other processes cannot interfere.

The disclosed hotpatching mechanisms may support ordered patch application, ensuring that updates are applied in a predictable and controlled manner. Each patch may be associated with a metadata version identifier, which specifies the minimum firmware version required for compatibility. The patch ordering mechanism may provide technical benefits including, for example, preventing dependency issues by ensuring that prerequisite patches are applied before dependent patches, maintaining firmware integrity by avoiding conflicts where an earlier patch could be overwritten or invalidated by a later patch, facilitating rollback management by enabling the system to track patch history and revert to a stable configuration if needed. Such patch ordering may be enforced, for example, through the URP framework, which maintains a log of applied patches and ensures that updates are installed sequentially according to their designated order.

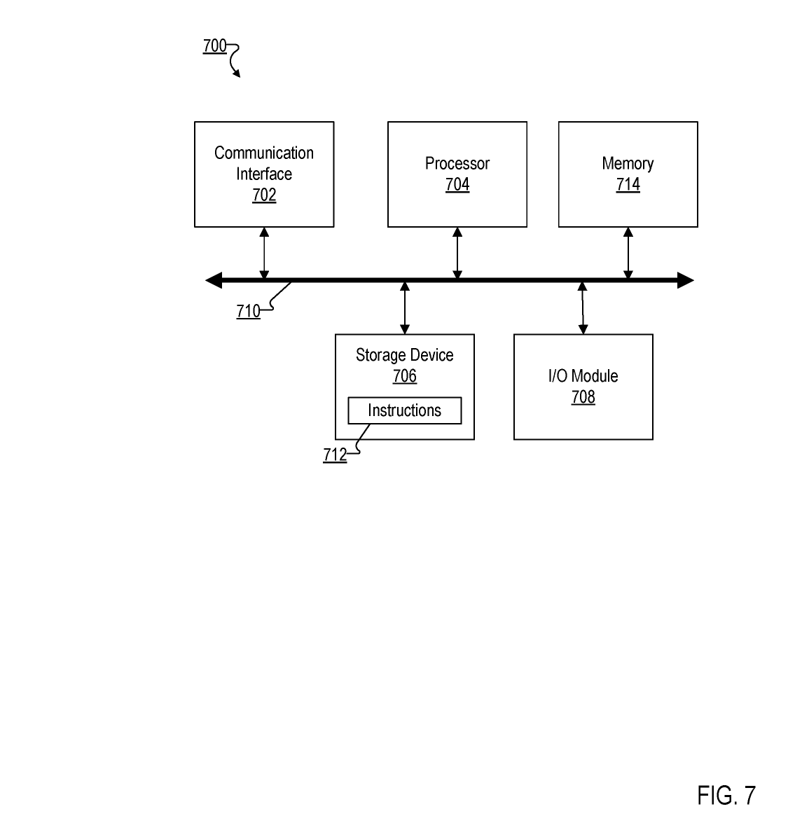

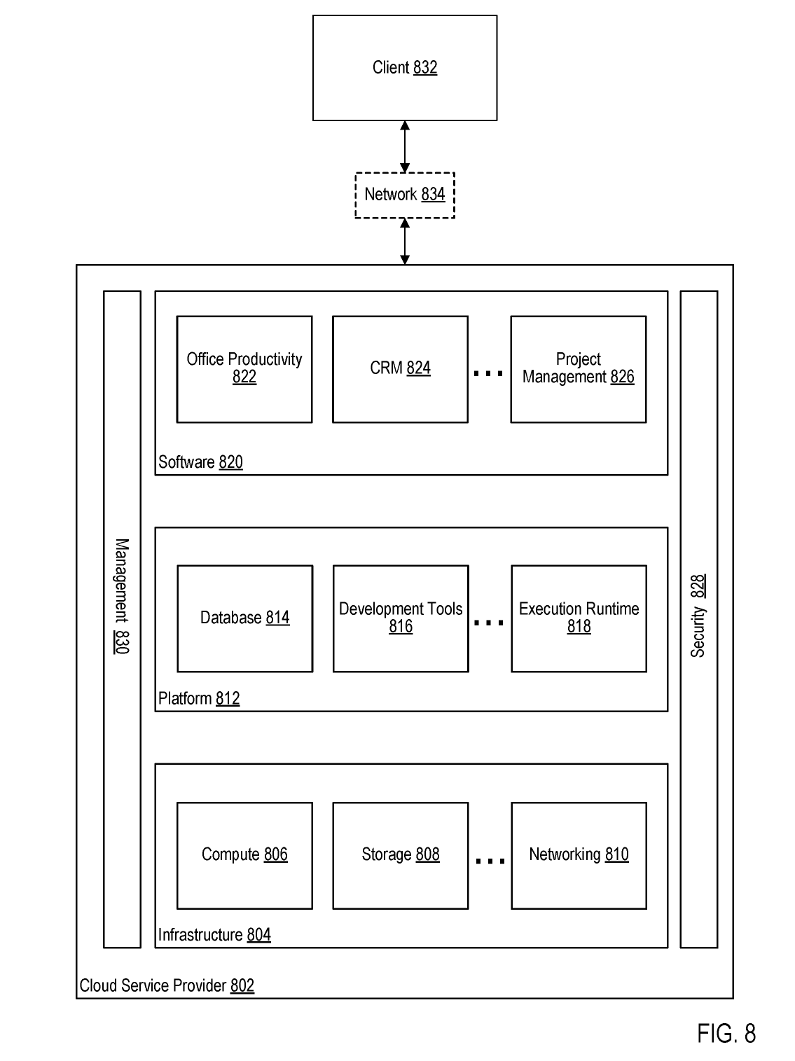

For further explanation, the sections included below provide some details regarding technologies that may be used to support runtime firmware updates using hotpatching in accordance with one or more embodiments. For example, FIG. 7 sets forth an example of a computing device that may be used for some portion of securing an operating system in accordance with one or more embodiments. As an additional example of technologies that may be used to support runtime firmware updates using hotpatching, FIG. 8 sets forth a block diagram of a cloud service provider 802 service architecture in accordance with one or more embodiments of the present disclosure.

For further explanation, FIG. 7 illustrates an exemplary computing device 700 that may be specifically configured to perform one or more of the processes described herein. As shown in FIG. 7, computing device 700 may include a communication interface 702, a processor 704, a storage device 706, an input/output (I/O) module 708, and computer memory 714 communicatively connected one to another via a communication infrastructure 710. While an exemplary computing device 700 is shown in FIG. 7, the components illustrated in FIG. 7 are not intended to be limiting. Additional or alternative components may be used in other embodiments. Components of computing device 700 shown in FIG. 7 will now be described in additional detail.

Communication interface 702 may be configured to communicate with one or more computing devices. Examples of communication interface 702 include, without limitation, a wired network interface (such as a network interface card), a wireless network interface (such as a wireless network interface card), a modem, an audio/video connection, and any other suitable interface.

Processor 704 generally represents any type or form of processing unit capable of processing data and/or interpreting, executing, and/or directing execution of one or more of the instructions, processes, and/or operations described herein. Processor 704 may perform operations by executing computer-executable instructions 712 (e.g., an application, software, code, and/or other executable data instance) stored in storage device 706.

Storage device 706 may include one or more data storage media, devices, or configurations and may employ any type, form, and combination of data storage media and/or device. For example, storage device 706 may include, but is not limited to, any combination of non-volatile media and/or volatile media. Electronic data, including data described herein, may be temporarily and/or permanently stored in storage device 706. For example, data representative of computer-executable instructions 712 configured to direct processor 704 to perform any of the operations described herein may be stored within storage device 706. In some examples, data may be arranged in one or more databases residing within storage device 706.

I/O module 708 may include one or more I/O modules configured to receive user input and provide user output. I/O module 708 may include any hardware, firmware, software, or combination thereof supportive of input and output capabilities. For example, I/O module 708 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 708 is configured to provide graphical data to a display for presentation to a user. The graphical data may be representative of one or more graphical user interfaces and/or any other graphical content as may serve a particular implementation. In some examples, any of the systems, computing devices, and/or other components described herein may be implemented by computing device 700.

For further explanation and as an additional example of a supporting technology for runtime firmware updates using hotpatching, FIG. 8 sets forth a block diagram of a cloud service provider service architecture in accordance with one or more embodiments. The cloud service provider 802 can deliver a variety of resources through a services-based consumption model where resources are consumed on-demand and as-a-service. Cloud service providers can provide services via cloud platforms such as, for example, Microsoft Azure^{TM}, Amazon Web Services (‘AWS’)^{TM}, Google Cloud Platform (‘GCP’)^{TM}, and others. In FIG. 8, the cloud service provider 802 is accessed from a client device 834 via a network 832.

FIG. 8 depicts an embodiment where software 820 is delivered as a service. Software-as-a-service (‘SaaS’) is a model where software applications are delivered over the internet as-a-service. Rather than installing and maintaining software locally, users can access software via a web browser or other network connected interface, eliminating the need for complex software and hardware management on the client-side. In FIG. 8, as examples of software 820 that can be delivered as-a-service, the illustrated embodiment includes office productivity 822 software, customer relationship management (‘CRM’) 824 software, and project management 826 software. The office productivity 822 software can include applications designed to facilitate common business and personal tasks, including word processing applications, applications for spreadsheet creation, presentation design applications, and many others. The CRM 824 software can include applications for managing a business organization’s relationships and interactions with customers and potential customers. The project management 826 software can include applications designed to help teams plan, organize, and manage projects efficiently by facilitating collaboration and tracking the progress of projects. Readers will appreciate that in other embodiments, other types of software may be delivered using a SaaS model.

FIG. 8 depicts an embodiment where platforms 812 can be delivered as a service. Platform-as-a-service (‘PaaS’) is a model that provides cloud customers with platform resources that they can use to develop, run, and manage applications without the complexity of such deploying and managing such infrastructure on their own. In FIG. 8, as examples of platform 812 resources that can be delivered as-a-service, the illustrated embodiment includes database 814 services, development tools 816 services, and execution runtime 818 services. The database 814 services can be used to provide access to databases without management overhead for the user as the cloud service provider manages the provisioning, scaling, and maintenance of the databases. The development tools 816 services can provide developers with tools to design, develop, test, and deploy applications without needing to manage the underlying infrastructure. The execution runtime 818 services can provide environments where applications or other forms of computer program code can be executed, including services to scale the execution environment. Readers will appreciate that in other embodiments, other platform resources may be delivered using a PaaS model.

FIG. 8 depicts an embodiment where infrastructure 804 can be delivered as a service. Infrastructure-as-a-Service (‘IaaS’) is a model that provides virtualized computing resources over the internet, such that infrastructure such as servers, storage, networks, and others may be leased on demand rather than purchasing and maintaining physical hardware. In FIG. 8, as examples of infrastructure 804 resources that can be delivered as-a-service, the illustrated embodiment includes compute 806 services, storage 808 services, and networking 810 services. The compute 806 services can be used to provide on-demand access to computational resources such as VMs, containers, and serverless functions, where the cloud service provider manages the provisioning, scaling, and maintenance of such resources. The storage 808 services can provide storage resources that can be used to store and access data, without the need for customers to purchase and manage on-premises physical storage resources. The networking 810 services can provide the ability to create and manage virtualized networking resources such as, for example, virtual private networks (‘VPNs’), firewalls, load balancers, and more. Readers will appreciate that in other embodiments, other infrastructure resources may be delivered using a PaaS model.

The cloud service provider of FIG. 8 also provides management 830 resources. The management 830 resources can include, for example, tools and interfaces that enable customers to efficiently deploy, monitor, and manage, their cloud services. Such tools can include web-based management consoles, command-line interfaces (‘CLIs’), APIs, automation tools, and other tools.

The cloud service provider of FIG. 8 also provides security 828 resources. The security 828 resources can include, for example, tools and services to help customers protect their cloud environments and ensure compliance with security standards. These tools and services may provide specific aspects of security, including identity and access management, network security, threat detection, compliance management, and others.

Readers will appreciate that many of the components described above may be delivered as services from a cloud service provider. For example, the virtual machines, containers, and pods described above may all be delivered via a cloud service provider. In other embodiments, other forms of compute resources may be used in place of the virtual machines or other compute resource. For example, AWS EC2 instances or other form of cloud compute instances may be utilized in place of the virtual machines.

Advantages and features of the present disclosure can be further described by the following statements:
1. A method of runtime firmware updates using hotpatching, comprising: storing, in a runtime buffer, a firmware update patch comprising an updated code segment for a firmware module loaded into system memory for execution; adding, to the firmware module and at a location corresponding to a code segment updated by the updated code segment, a redirect command directed to the updated code segment; and wherein the redirect command, when executed, causes the updated code segment to be executed instead of the code segment.
2. The method of statement 1, wherein adding the redirect command further comprises: generating an interrupt event that enables an operating mode suspending execution of code other than a handler for the interrupt event; adding the redirect command by the handler for the interrupt event; and releasing, after adding the redirect command, the operating mode.
3. The method of statements 1 or 2, wherein the operating mode comprises a System Management Mode (SMM) operating mode.
4. The method of any combination of one or more of statements 1-3, wherein the firmware update patch comprises a plurality of updated code segments including the updated code segment and wherein adding the redirect command comprises adding a plurality of redirect commands to one or more firmware modules including the firmware module, wherein each of the plurality of redirect commands are directed to a corresponding updated code segment of the plurality of updated code segments.
5. The method of any combination of one or more of statements 1-4, wherein the plurality of redirect commands are added to the firmware module in an order defined in metadata for the update patch.
6. The method of any combination of one or more of statements 1-5, further comprising: storing, in the runtime buffer, another firmware update patch comprising another updated code segment for the firmware module, wherein the other updated code segment updates the code segment updated by the updated code segment; removing the redirect command from the firmware module; and adding another redirect command directed to the other updated code segment.
7. The method of any combination of one or more of statements 1-6, wherein the firmware update patch comprises a Unified Extensible Framework Interface (UEFI) Runtime Patch (URP) capsule and wherein the firmware module comprises a UEFI firmware module.
8. An apparatus for runtime firmware updates using hotpatching, comprising: a memory; and one or more processing devices, operatively coupled to the memory, the one or more processing devices configured to: store, in a runtime buffer, a firmware update patch comprising an updated code segment for a firmware module loaded into system memory for execution; add, to the firmware module and at a location corresponding to a code segment updated by the updated code segment, a redirect command directed to the updated code segment; and wherein the redirect command, when executed, causes the updated code segment to be executed instead of the code segment.
9. The apparatus of statement 8, wherein, to add the redirect command, the one or more processing devices are further configured to: generate an interrupt event that enables an operating mode suspending execution of code other than a handler for the interrupt event; add the redirect command by the handler for the interrupt event; and release, after adding the redirect command, the operating mode.
10. The apparatus of statements 8 or 9, wherein the operating mode comprises a System Management Mode (SMM) operating mode.
11. The apparatus of any combination of one or more of statements 8-10, wherein the firmware update patch comprises a plurality of updated code segments including the updated code segment and wherein, to add the redirect command, the one or more processing devices are further configured to add a plurality of redirect commands to one or more firmware modules including the firmware module, wherein each of the plurality of redirect commands are directed to a corresponding updated code segment of the plurality of updated code segments.
12. The apparatus of any combination of one or more of statements 8-11, wherein the plurality of redirect commands are added to the firmware module in an order defined in metadata for the update patch.
13. The apparatus of any combination of one or more of statements 8-12, wherein the one or more processing devices are further configured to: storing, in the runtime buffer, another firmware update patch comprising another updated code segment for the firmware module, wherein the other updated code segment updates the code segment updated by the updated code segment; removing the redirect command from the firmware module; and adding another redirect command directed to the other updated code segment.
14. The apparatus of any combination of one or more of statements 8-13, wherein the firmware update patch comprises a Unified Extensible Framework Interface (UEFI) Runtime Patch (URP) capsule and wherein the firmware module comprises a UEFI firmware module.
15. A non-transitory computer readable storage medium storing instructions which, when executed, cause a processing device to: store, in a runtime buffer, a firmware update patch comprising an updated code segment for a firmware module loaded into system memory for execution; add, to the firmware module and at a location corresponding to a code segment updated by the updated code segment, a redirect command directed to the updated code segment; and wherein the redirect command, when executed, causes the updated code segment to be executed instead of the code segment.
16. The non-transitory computer readable storage medium of statements 15 or 16, wherein, to add the redirect command, the instructions, when executed, further cause the processing device to: generate an interrupt event that enables an operating mode suspending execution of code other than a handler for the interrupt event; add the redirect command by the handler for the interrupt event; and release, after adding the redirect command, the operating mode.
17. The non-transitory computer readable storage medium of statements 15 or 16, wherein the operating mode comprises a System Management Mode (SMM) operating mode.
18. The non-transitory computer readable storage medium of any combination of one or more of statements 15-17, wherein the firmware update patch comprises a plurality of updated code segments including the updated code segment and wherein, to add the redirect command, the instructions, when executed, further cause the processing device to add a plurality of redirect commands to one or more firmware modules including the firmware module, wherein each of the plurality of redirect commands are directed to a corresponding updated code segment of the plurality of updated code segments.
19. The non-transitory computer readable storage medium of any combination of one or more of statements 15-18, wherein the plurality of redirect commands are added to the firmware module in an order defined in metadata for the update patch.
20. The non-transitory computer readable storage medium of claim 15, wherein the instructions, when executed, further cause the processing device to: storing, in the runtime buffer, another firmware update patch comprising another updated code segment for the firmware module, wherein the other updated code segment updates the code segment updated by the updated code segment; removing the redirect command from the firmware module; and adding another redirect command directed to the other updated code segment.

Although one or more embodiments are described largely in the context of a system, method, or in some other way, readers will recognize that embodiments of the present disclosure may also take the form of a computer program product disposed upon computer readable storage media for use with any suitable processing system. Such computer readable storage media may be any storage medium for machine-readable information, including magnetic media, optical media, solid-state media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps described herein as embodied in a computer program product. Persons skilled in the art will recognize also that, although some of the embodiments described in this specification are oriented to software installed and executing on computer hardware, nevertheless, alternative embodiments implemented as firmware or as hardware are well within the scope of the present disclosure.

Readers will appreciate that one or more embodiments are described in which computer program instructions are executed on computer hardware such as, for example, one or more computer processors. Readers will appreciate that in other embodiments, computer program instructions may be executed on virtualized computer hardware (e.g., one or more virtual machines), in one or more containers, in one or more cloud computing instances (e.g., one or more AWS EC2 instances), in one or more serverless compute instances offered such as those offered by a cloud services provider, in one or more event-driven compute services such as those offered by a cloud services provider, or in some other execution environment.

In some examples, a non-transitory computer-readable medium storing computer-readable instructions may be provided in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g., a hard disk, a floppy disk, magnetic tape, etc.), ferroelectric random-access memory ("RAM"), and an optical disc (e.g., a compact disc, a digital video disc, a Blu-ray disc, etc.). Exemplary volatile storage media include, but are not limited to, RAM (e.g., dynamic RAM).

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

While particular combinations of various functions and features of the one or more embodiments are expressly described herein, other combinations of these features and functions are likewise possible. The present disclosure is not limited by the particular examples disclosed herein and expressly incorporates these other combinations.

What is claimed is:

1. A method of runtime firmware updates using hotpatching, comprising:
storing, in a runtime buffer, a firmware update patch comprising an updated code segment for a firmware module loaded into system memory for execution;
adding, to the firmware module and at a location corresponding to a code segment updated by the updated code segment, a redirect command directed to the updated code segment; and
wherein the redirect command, when executed, causes the updated code segment to be executed instead of the code segment.

2. The method of claim 1, wherein adding the redirect command further comprises:
generating an interrupt event that enables an operating mode suspending execution of code other than a handler for the interrupt event;
adding the redirect command by the handler for the interrupt event; and
releasing, after adding the redirect command, the operating mode.

3. The method of claim 2, wherein the operating mode comprises a System Management Mode (SMM) operating mode.

4. The method of claim 1, wherein the firmware update patch comprises a plurality of updated code segments including the updated code segment and wherein adding the redirect command comprises adding a plurality of redirect commands to one or more firmware modules including the firmware module, wherein each of the plurality of redirect commands are directed to a corresponding updated code segment of the plurality of updated code segments.

5. The method of claim 4, wherein the plurality of redirect commands are added to the firmware module in an order defined in metadata for the update patch.

6. The method of claim 1, further comprising:
storing, in the runtime buffer, another firmware update patch comprising another updated code segment for the firmware module, wherein the other updated code segment updates the code segment updated by the updated code segment;
removing the redirect command from the firmware module; and
adding another redirect command directed to the other updated code segment.

7. The method of claim 1, wherein the firmware update patch comprises a Unified Extensible Framework Interface (UEFI) Runtime Patch (URP) capsule and wherein the firmware module comprises a UEFI firmware module.

8. An apparatus for runtime firmware updates using hotpatching, comprising:
a memory; and
one or more processing devices, operatively coupled to the memory, the one or more processing devices configured to:
store, in a runtime buffer, a firmware update patch comprising an updated code segment for a firmware module loaded into system memory for execution;
add, to the firmware module and at a location corresponding to a code segment updated by the updated code segment, a redirect command directed to the updated code segment; and
wherein the redirect command, when executed, causes the updated code segment to be executed instead of the code segment.

9. The apparatus of claim 8, wherein, to add the redirect command, the one or more processing devices are further configured to:
generate an interrupt event that enables an operating mode suspending execution of code other than a handler for the interrupt event;
add the redirect command by the handler for the interrupt event; and
release, after adding the redirect command, the operating mode.

10. The apparatus of claim 9, wherein the operating mode comprises a System Management Mode (SMM) operating mode.

11. The apparatus of claim 8, wherein the firmware update patch comprises a plurality of updated code segments including the updated code segment and wherein, to add the redirect command, the one or more processing devices are further configured to add a plurality of redirect commands to one or more firmware modules including the firmware module, wherein each of the plurality of redirect commands are directed to a corresponding updated code segment of the plurality of updated code segments.

12. The apparatus of claim 11, wherein the plurality of redirect commands are added to the firmware module in an order defined in metadata for the update patch.

13. The apparatus of claim 8, wherein the one or more processing devices are further configured to:
storing, in the runtime buffer, another firmware update patch comprising another updated code segment for the firmware module, wherein the other updated code segment updates the code segment updated by the updated code segment;
removing the redirect command from the firmware module; and
adding another redirect command directed to the other updated code segment.

14. The apparatus of claim 8, wherein the firmware update patch comprises a Unified Extensible Framework Interface (UEFI) Runtime Patch (URP) capsule and wherein the firmware module comprises a UEFI firmware module.

15. A non-transitory computer readable storage medium storing instructions which, when executed, cause a processing device to:
store, in a runtime buffer, a firmware update patch comprising an updated code segment for a firmware module loaded into system memory for execution;
add, to the firmware module and at a location corresponding to a code segment updated by the updated code segment, a redirect command directed to the updated code segment; and
wherein the redirect command, when executed, causes the updated code segment to be executed instead of the code segment.

16. The non-transitory computer readable storage medium of claim 15, wherein, to add the redirect command, the instructions, when executed, further cause the processing device to:
generate an interrupt event that enables an operating mode suspending execution of code other than a handler for the interrupt event;
add the redirect command by the handler for the interrupt event; and
release, after adding the redirect command, the operating mode.

17. The non-transitory computer readable storage medium of claim 16, wherein the operating mode comprises a System Management Mode (SMM) operating mode.

18. The non-transitory computer readable storage medium of claim 15, wherein the firmware update patch comprises a plurality of updated code segments including the updated code segment and wherein, to add the redirect command, the instructions, when executed, further cause the processing device to add a plurality of redirect commands to one or more firmware modules including the firmware module, wherein each of the plurality of redirect commands are directed to a corresponding updated code segment of the plurality of updated code segments.

19. The non-transitory computer readable storage medium of claim 18, wherein the plurality of redirect commands are added to the firmware module in an order defined in metadata for the update patch.

20. The non-transitory computer readable storage medium of claim 15, wherein the instructions, when executed, further cause the processing device to:
storing, in the runtime buffer, another firmware update patch comprising another updated code segment for the firmware module, wherein the other updated code segment updates the code segment updated by the updated code segment;
removing the redirect command from the firmware module; and
adding another redirect command directed to the other updated code segment.
